(19) United States
(12) Patent Application Publication
(10) Pub. No.: US 2011/0053607 A1
(43) Pub. Date: Mar. 3, 2011

(54) SYSTEM FOR CONNECTION TO MOBILE PHONE NETWORKS

(76) Inventor: Constantine Anthony Michael, Swanbourne (AU)

(21) Appl. No.: 12/867,176

(22) PCT Filed: Feb. 11, 2008
(86) PCT No.: PCT/AU2008/000161

§ 371 Date: Nov. 19, 2010

(51) Int. Cl. H04W 24/00; H01Q 1/28

(52) U.S. Cl. 455/456.1; 343/705

(57) ABSTRACT

A system (10) for providing connectivity to a mobile phone network having a plurality of towers providing wireless access to the network, includes a base (16) having one or more control motors (20, 22) connected to the base to rotate the base and one or more directional antennas (14) mounted on the base. A means is provided to determine the current location and orientation of the antennas (14) and a central control unit is provided in communication with each control motor (20, 22) and the means. A database accessible by the central control unit contains information relating to the location of each of the towers and the central control unit determines the most suitable tower for connection to the system (10). The control motor rotates the base (16) such that the directional antenna (14) is pointing in the direction of said tower.

### FIELD OF THE INVENTION

The present invention relates to a system for providing connection to a mobile phone network.

### BACKGROUND TO THE INVENTION

At present, access to communications networks for watercraft and land vehicles in remote areas is primarily available via satellite connections. Ocean going vessels for example will commonly utilise a satellite connection to provide broadband and voice access to a telecommunication network.

A significant issue surrounding the use of satellite connectivity is cost. While satellite connections provide the required functionality, the costs for voice and data traffic are extremely high relative to, for example, connections over a mobile phone network. Further, the available connection speeds are also relatively low.

3G mobile phone networks, for example, however are providing increasingly high connection speeds and lower costs for data transfer. Connection to such mobile networks though is only presently possible within a fairly limited range of the mobile towers. That is, in close range of the coast in the case of ocean going vessels.

The present invention attempts to overcome, at least in part, the abovementioned disadvantages of access to communication networks via satellite by providing a system with connectivity to a mobile network over increased distances.

References to prior art in this specification are provided for illustrative purposes only and are not to be taken as an admission that such prior art is part of the common general knowledge in Australia or elsewhere.

### SUMMARY OF THE INVENTION

In accordance with the present invention, there is provided a system for providing connectivity to a mobile phone network having a plurality of towers providing wireless access to the network, the system comprising having:

a base having one or more control motors connected to the base to rotate the base;
one or more directional antennas mounted on the base, where the one or more directional antennas includes a first directional antenna and a second directional antenna, each disposed on opposite sides of the base so as to be rotatable about an axis therebetween;
a means to determine the current location and orientation of the antennas;
a central control unit in communication with the or each control motor and the means to determine the current location and orientation of the antennas; and
a database accessible by the central control unit containing information relating to the location of each of the towers;
wherein the central control unit determines the most suitable tower for connection to the system by accessing the database and the current position and controls the or each control motor to rotate the base such that the first directional antenna and the second directional antenna point in the direction of the tower.

Preferably, the means to determine the current location and orientation of the antenna includes a GPS unit and an electronic compass. The electronic compass may comprise a fluxgate compass, GPS compass or other suitable compass.

Preferably, the base is mounted also for rotation in a vertical plane and a first control motor is provided for rotating the base in the horizontal plane and a second motor is provided for rotating the base in the vertical plane.

The directional antennas may comprise Yagi antennas. In one embodiment, a pair of Yagi antennas are provided.

In one embodiment, the central control unit includes a microcontroller and software provided for accessing the database and determining the most suitable tower for connection. The most suitable tower may comprise the closest tower to the antenna.

Advantageously, the software includes a means to direct the antennas away from the tower, if the tower is determined to be closer than a predetermined minimum distance. Preferably, the antenna is directed away from the tower such that transmission is via a side lobe of the antenna.

Preferably, the system includes a means to receive information from the craft on which the system is mounted regarding the movement of the craft and said information is also used to control rotation of the antenna.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of preferred embodiments of the system, given by way of example only, with reference to the accompanying drawings, in which:

FIG. 1 is a block diagram of the system of the present invention;

FIG. 2 is a side cross sectional view of an outdoor unit of the system of the present invention; and

FIG. 3 is a top cross sectional view of the outdoor unit.

### DETAILED DESCRIPTION OF PREFERRED EMBODIMENTS

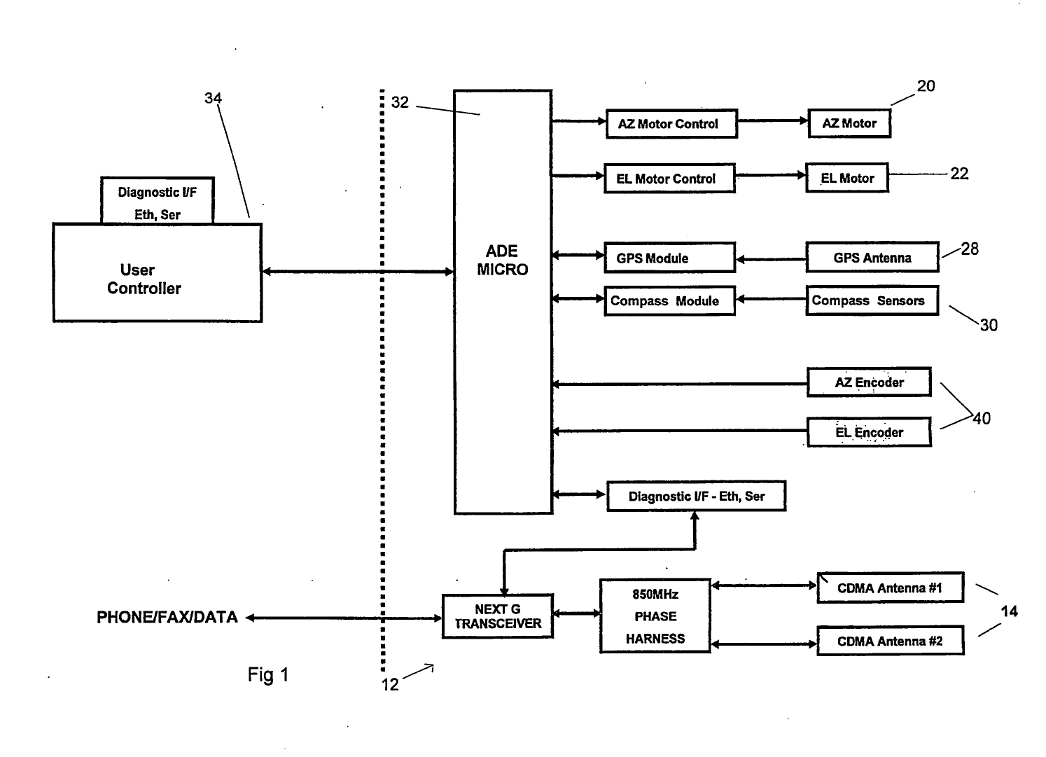

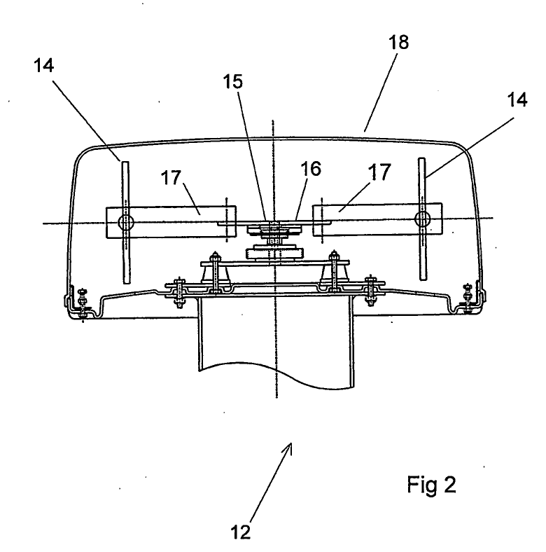

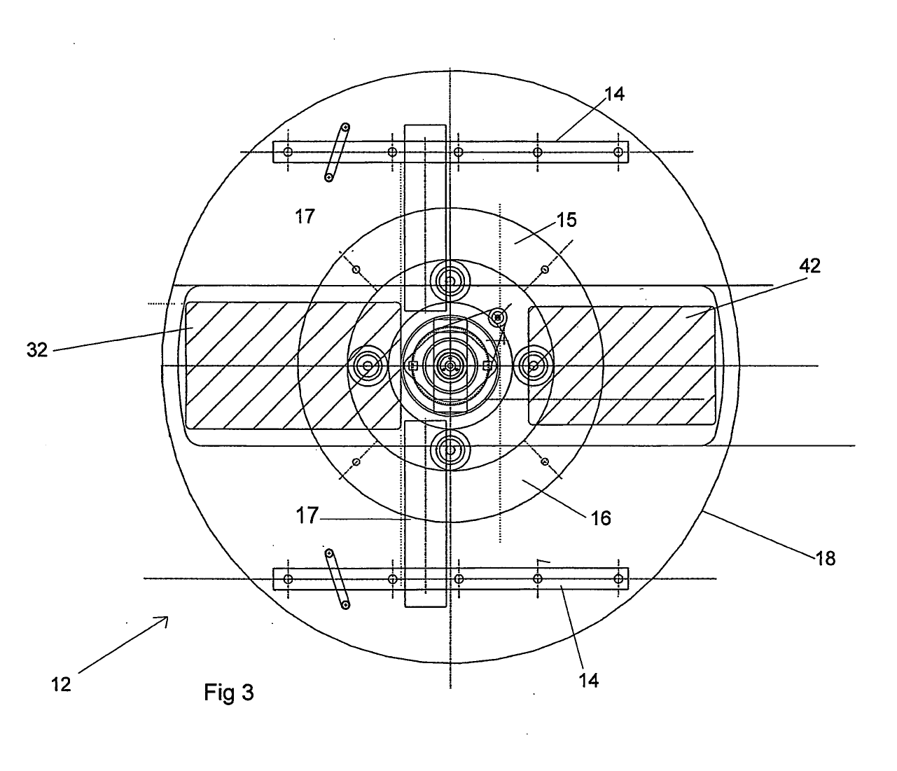

A preferred embodiment of the system 10 in accordance with the invention, as illustrated in FIGS. 1 to 3, comprises an outdoor unit 12 having one or more directional antennas 14. In the embodiment shown in the Figures, the outdoor unit 12 is provided with a pair of Yagi antennas 14.

The antennas 12 are mounted on a rotating base 16. The base 16 is mounted within an enclosure 18 such that the base 16 is rotatable in a horizontal plane. The enclosure 18 includes a first control motor 20 which rotates the base 16 about a vertical axis. That is, the first control motor 20 varies the azimuth of the antennas 14. In the embodiment shown, the base comprises a disc 17 having horizontally extending arms 19. The antennas 14 are mounted adjacent ends of the arms 17.

The enclosure may also includes a second control motor 22 which rotates the antennas 14 about a horizontal axis. That is, the second control motor 22 varies the elevation of the antennas 14. An embodiment in which the base 16 is only rotatable in a horizontal plane may be utilised if the vertical movement of the craft on which the system is mounted and the directionality of the antenna in a vertical plane are suitable.

The system 10 also includes a GPS unit 28. The GPS unit is provided to determine the current coordinates of the system 10. Also provided is an electronic compass 30 comprising a sensor provided on the base 16 connected to a compass module. The electronic compass 30 is provided to determine the current orientation of the base 16. The electronic compass 30 can therefore provide the current direction in which antennas 14 are pointed. The electronic compass 30 may comprise a fluxgate compass, GPS compass or other suitable compass.

The system 10 is provided with a central control unit comprising a microcontroller 32 which may also be located also in the enclosure 18. The microcontroller 32 is in communication with the GPS unit 28 and the electronic compass 30 such that the microcontroller 32 is provided with information of the current coordinates of the enclosure 18 and the current direction of the antennas 14. The microcontroller 32 is also connected to the first and second control motors 20 and 22 such that the microcontroller 32 can drive the first and second control motors 20 and 22 in response to signals received from the GPS unit 28 and the electronic compass 30.

The system 10 is also provided with software which includes a database containing the coordinates of mobile phone towers which the system can use for connection to a telecommunications network. The software includes means to compare the current position to the coordinates of the towers in the database and determine which tower is the closest or most suitable tower to use for connection to the telecommunication network. In the embodiment shown in the figures, the telecommunication network comprises the Next G mobile network and the antennas 14 are therefore provided with an 850 MHz phase harness and Next G transceiver 42 to provide phone, fax and data connection to the network.

The system may also be provided with a means to monitor the signal strength received from a tower and adjust the direction of the antennas 14 based on received signal strength. That is, the system can rotate the antennas 14 through a range of movement and determine the direction at which the maximum signal strength is present. Such a method may be used in circumstances where the location of the towers is unknown.

The system 10 is also provided with means to monitor movement and/or orientation of the vessel or vehicle on which the system 10 is mounted. The means may include one or more accelerometers to provide information regarding movement of the vessel or vehicle. This information is processed in encoders 40 along with the information provided by the electronic compass 30 and GPS unit 28 and used by the microcontroller to control movement of the antennas 14. Providing information regarding movement and orientation of the vessel allows increased response time for movement of the antennas 14 relative to only using the signals provided by the GPS unit 28 and the electronic compass 30. As the GPS unit 28 and electronic compass 30 will have associated delays before detecting orientation or position changes, information provided regarding movement will allow the system 10 to predict changes required to the direction of the antennas 14. Further, knowledge of the orientation would allow for appropriate action if, for example, the vessel were in a position in which a known obstruction on the vessel were to fall between the antennas 14 and the tower.

In use, the software determines which tower is the most suitable tower for providing network access based on the current location. The microcontroller operates the first and second control motors 20 and 22 to rotate the antennas 14 such that the antennas 14 are directed towards this tower. The signals provided by the encoders 40 are used to determine the movement required by the first and second control motors 20 and 22 for the antennas 14 to track the tower.

Should at any time the software determine that a further tower is closer or more suitable for network access, the system alters the direction of the antennas 14 automatically such that the antennas 14 are directed towards this tower.

The software includes means to determine whether the tower to which the antennas 14 are currently directed becomes too close. The use of such directional antennas 14 may affect the operation of the tower in close range due to the increased signal strength. Therefore, the software on determining that the current tower is closer than a predetermined minimum distance, will rotate the antennas 14 away from the tower. The antennas 14 may be rotated such that the antennas 14 transmit and receive signals via the side lobes, thereby decreasing the signal strength.

The system 10 also includes an indoor controller 34 providing user access to the system 10. The user access may comprise a graphical user interface providing access to the system 10 for configuration and maintenance purposes.

The system 10 as described above may provide voice and data connection to a mobile phone network over distances in excess of 100 km. For craft working within such ranges, the system thereby provides a reliable connection at a significantly reduced cost and with higher data transfer speeds than existing satellite services.

It will be readily apparent to persons skilled in the relevant arts that various modifications and improvements may be made to the foregoing embodiments, in addition to those already described, without departing from the basic inventive concepts of the present invention. Therefore, it will be appreciated that the scope of the invention is not limited to the specific embodiments described and is to be determined from the appended claims.

1. A system for providing connectivity to a mobile phone network having a plurality of towers providing wireless access to the network, the system comprising having:
a base having one or more control motors connected to the base to rotate the base;
one or more directional antennas mounted on the base, where the one or more directional antennas includes a first directional antenna and a second directional antenna, each disposed on opposite sides of the base so as to be rotatable about an axis therebetween;
a means to determine the current location and orientation of the antennas;
a central control unit in communication with the or each control motor and the means to determine the current location and orientation of the antennas; and
a database accessible by the central control unit containing information relating to the location of each of the towers;
wherein the central control unit determines the most suitable tower for connection to the system by accessing the database and the current position and controls the or each control motor to rotate the base such that the first directional antenna and the second directional antenna point in the direction of the tower.

2. A system in accordance with claim 1, wherein the means to determine the current location and orientation of the antenna includes a GPS unit and an electronic compass.

3. A system in accordance with claim 1 or 2, wherein the base is mounted also for rotation in a vertical plane and a first control motor is provided for rotating the base in the horizontal plane and a second motor is provided for rotating the base in the vertical plane.

4. A system in accordance with any one of claims 1 to 3, wherein the directional antennas comprise Yagi antennas.

5. A system in accordance with claim 4, wherein a pair of Yagi antennas are provided.

6. A system in accordance with any one of the preceding claims, wherein the central control unit includes a microcontroller and software provided for accessing the database and determining the most suitable tower for connection.

7. A system in accordance with claim 6, wherein the most suitable tower comprises the closest tower to the antenna.

8. A system in accordance with claim 6 or 7, wherein the software includes a means to direct the antennas away from the tower, if the tower is determined to be closer than a predetermined minimum distance.

9. A system in accordance with claim 8, wherein the antenna is directed away from the tower such that transmission is via a side lobe of the antenna.

10. A system in accordance with any one of the preceding claims, wherein the system includes a means to receive information from the craft on which the system is mounted regarding the movement of the craft and said information is used to control rotation of the antenna.

11. A system in accordance with any one of the preceding claims, wherein the base and antennas are provided within a sealed enclosure.
